(19) United States
(12) Patent Application Publication
(10) Pub. No.: US 2024/0138414 A1
(43) Pub. Date: May 2, 2024

(54) Compound peroxylactic acid solution and method for manufacturing food grade sanitizer

(71) Applicants: THOMAS MICHAEL ELLSWORTH, Nashville, TN (US); BIOCIDE SOLUTIONS, LLC, Nashville, TN (US)

(72) Inventor: Thomas Michael Ellsworth, Nashville, TN (US)

(21) Appl. No.: 17/803,724

(22) Filed: Oct. 28, 2022

(51) Int. Cl. A01N 59/00; A01N 37/02; A01N 43/40; A01N 57/20; A01P 1/00; A23B 4/12; A23B 4/24; A23B 7/10; A23B 7/157; A23L 3/3508; A23L 3/3544; A23L 3/358

(52) U.S. Cl. CPC A01N 59/00; A01N 37/02; A01N 43/40; A01N 57/20; A01P 1/00; A23B 4/12; A23B 4/24; A23B 7/10; A23B 7/157; A23L 3/3508; A23L 3/3544; A23L 3/358; A23V 2002/00

(57) ABSTRACT

The primary objective of the present invention is to provide a stable formulation for a food grade sanitizer with an extended shelf-life. In certain embodiments, this solution is an effective oxidizing biocide that has additional uses in a wide variety of industries including industrial, medical, military, and household applications in addition to food manufacturing and sanitation. The use of peroxylactic acid is limited or non-existent at this point in the food manufacturing industry.

### FIELD

The present invention is directed to solutions and methods for an improved food grade sanitizer.

### BACKGROUND OF THE INVENTION

A food grade sanitizer is an agent which reduced contaminants such as bacteria to levels considered safe by public health requirements. Ideally, a food grade sanitizer will possess several components: the ability to sufficiently reduce common and potentially harmful bacterias such as Escherichia coli and Salmonella Typhimurium, be comprised of a formula sufficient to prevent reaction shifting, and be shelf-stable long enough to be marketable. Finally, the breakdown of the components needs to be environmentally compatible.

The food sanitizing industry relies on ultra-precise formulas in order to prevent a shifting of the reaction which would result in a poor product. Currently, the most common food grade sanitizers are peroxyacetic acid, sodium hypochlorite, chlorine dioxide, and acidified sodium chlorite. While each of these sanitizers are effective, each chemistry has one or more undesirable properties, odor, hazardous nature, a two-part system, or byproducts.

Peroxylactic acid (PLA) is not commonly used in the industry for sanitizing food products. The most important and longest part of the development is the formulation. Reaction shifts result in poor product. In order to prevent a shifting of the reaction, equilibrium products require ultra-precise formulas.

Catalysts are necessary to decrease the cure time.

The shelf-life of the product has to be extended to at least 6 months to launch a desirable product. Utilizing raw materials with low concentrations of transition metals along with the correct formulation will determine the shelf-life of the product. Providing a shelf-life of 6 months is necessary in order to reach optimal implementation of the product to market.

Previous patents have directed attention to the formulation, necessary catalysts and shelf-life time. These fall short however because they fail to address the need for extended shelf-life times, and preventing reaction shift. For example, in U.S. Pat. No. 10,745,338 B1, the method for peroxylactic acid production and use for reduction in microbial activity in food product processing only provided for 90 days of shelf life. (Id. at Table 7) U.S. Pat. No. 6,534,075 B1 illustrated some of the problems with reaction shifts and an early breakdown as well discussing how certain combinations may create an oxidizing agent, but the activity is lost after a few days and the solution is no longer sanitizing.

As stated in U.S. Pat. No. 5,234,719 A, there has been a long felt need for antimicrobial agents which have a high degree of antimicrobial efficacy, and which are preferably safely ingestible by humans while posing no environmental incompatibility. Concerns of approved microbiocidal agents and their detrimental effect on the environment and contamination of water supply has lessened the available options. The present product has been confirmed by the Food and Drug Administration that PLA will break down into oxygen and lactic acid, while the hydrogen peroxide will break down into oxygen and water. The lactic acid is expected to dissociate in wastewater and degrade at wastewater treatment facilities. The HEDP and DPA are expected to degrade rapidly and no longer be present on the food when consumed.

The present compound solution formulation provides a shelf life of 180 days, double the amount of time in the prior art. The concentration of the chemistries is important in accomplishing this extension for product marketability.

REFERENCES

| | | |
|---|---|---|
| US 11, 325, 887 B2 | BALASUBRAMANIAN | 2022 |
| US 10, 745, 338 B1 | BULLARD | 2020 |
| US 9, 414, 609 | BULLARD | 2016 |
| US 6, 534, 075 B1 | HEI | 2003 |
| US 5, 858, 443 A | HEI | 1999 |
| US 5, 234, 719 A | RICHTER | 1993 |

### BRIEF SUMMARY OF THE INVENTION

The primary objective of the invention is to provide a food grade sanitizer with an ultra precise formulation to prevent shifting of reactions with an increase in shelf life to enhance product marketability.

The presently disclosed invention relates to a composition including Hydroxyethylidene Diphosphonic Acid (HEDP) and Dipicolinic Acid (DPA). Furthermore, Dipicolinic Acid is confirmed as biodegradable, and is among the least volatile, least absorbed by soil, and most rapidly degraded of the simple pyridines.

The present invention provides sanitation and biocide activity and a method of manufacturing a food grade sanitizer in order to avoid complications including acute decomposition reaction and prevent reaction shifts.

The present invention, in its best form, is able to double the shelf life of the product due to the enhanced stability provided by the careful handling of raw materials and blending process which contains low concentrations of transition metals.

The present invention is useful in the food manufacturing industry.

The present invention has additional uses in industrial, medical, military, and household applications. The present invention is an effective oxidizing biocide that has additional uses in a wide variety of industries including industrial, medical, military, and household applications in addition to food manufacturing and sanitation. The use of peroxylactic acid is limited or non-existent at present.

### BRIEF DESCRIPTION OF THE DRAWINGS

FIG. 1 illustrates a flow diagram of a preferred embodiment of the present invention.

### DETAILED DESCRIPTION AND BEST MODE OF IMPLEMENTATION

The present invention comprises compositions for a food grade sanitizer. Peroxylactic acid is a known sanitizer that is not common in the industry. Peroxylactic acid is created by blending food grade lactic acid with a food grade high purity hydrogen peroxide. Peroxylactic acid is an equilibrium reaction. A catalyst is added to speed up the cure time, sulfuric acid. Additional stabilizing agents, HEDP and DPA, are added to enhance the shelf life timeline. All raw materials used in implementing the best mode of this product contain low concentrations of transition metals in order to formulate a certain shelf life. This ensures that the product is shelf stable for 6 months.

In a preferred embodiment of this invention, 0.4 ounces of the formulated compound solution is mixed with one gallon of water to provide the optimal equilibrium for use as a food grade sanitizing agent.

In another embodiment of this invention, specialized, oxidant resistant chelating agents can be added to chelate and sequester the transition metals that are present and prevent degradation of the product thus, extending the shelf-life.

In another embodiment of this invention, this compound solution may be used in organic processing facilities for food contact surface sanitation.

In determining the best mode of implementation, the manufacturing and handling of peroxylactic acid determines the stability. Mishandling of the materials results in an acute decomposition reaction.

In all preferred embodiments of this invention, the compound solution provides double the shelf life of other products currently on the market and identified in the prior art. The precise use of formulaic equilibrium products, such as pure sulfuric acid in certain embodiments as a catalyst allows the cure time to decrease. To sequester the transition metals, the concentration of chemistries is important as a chelating agent. The specificity of the product is important

Additional benefits of this compound solution include the biodegradability of the chelating agent.

In all preferred embodiments of this invention, the concentration of chemistries is important and specificity necessary to slow the reaction shift, decrease cure time, and increase shelf life of the product.

[symbol]

In the preferred embodiments of this invention, the components making up this product are “food-grade” or allowed to indirectly or directly contact consumable food product, packaging, food production equipment or manufacturing equipment.

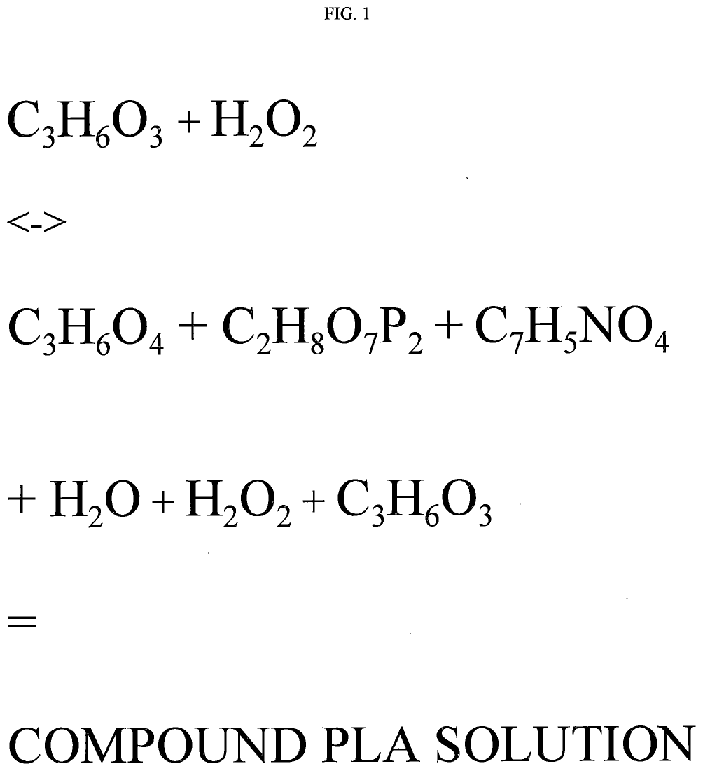

FIG. 1 illustrates the preferred embodiment of the compound peroxylactic acid solution. The solution is made by blending food grade lactic acid with high purity hydrogen peroxide. This is combined with hydrogen oxide and hydrogen peroxide and dipicolinic acid and hydroxyethylidene in order to chelate the solution and ensure a shelf-life of 6 months for the solution.

By blending a food grade lactic acid with a high purity food grade hydrogen peroxide, the equilibrium reaction results in peroxylactic acid which then breaks down into water and hydrogen peroxide and lactic acid. The addition of the chelating agents, such as HEDP and DPA further stabilize the product.

Tables 1 and 2 illustrate the solution stability over 8 weeks time, at a temperature of 72 and 72 degrees Fahrenheit.

Tables 3 and 4 illustrate the microbial efficacy of the compound solution against Escherichia coli at 150-ppm with a 1 minute contact time.

Tables 5 and 6 illustrate the microbial efficacy of the compound solution against Salmonella Typhimurium at 150-ppm with a 1 minute contact time.

Table 7 illustrates the preferred raw material percent in formula.

I claim:

1. A solution comprising a lactic acid, a hydrogen peroxide, a hydrogen oxide, a strong acid, a dipicolinic acid, and a hydroxyethylidene diphoshonic acid.

2. The solution in claim 1 in which the strong acid is comprised of a sulfuric acid.

3. The solution in claim 1 in which the lactic acid is a food grade lactic acid.

4. A method for preparation of food grade sanitizer, said method comprising the steps of:
(A) Combining a quantity of a lactic acid with a quantity of a hydrogen peroxide and a quantity of hydrogen oxide with a quantity of a strong acid to form a solution.
(B) Combining this solution with a quantity of dipicolinic acid and a quantity of hydroxyethylidene disphoshonic acid to form a compound solution.
(C) Combining this compound solution with a quantity of water.
(D) Applying the compound solution to cleanse industrial equipment.
(D) Applying the compound solution to clean food products, meat, poultry, seafood, and produce.

5. The method according to claim 4 in which the lactic acid is a food grade lactic acid.

6. The method according to claim 4 in which the strong acid is comprised of a sulfuric acid.

7. A method for preparation of food grade sanitizer, said method comprising the steps of:
(A) Combining an amount of lactic acid with an amount of hydrogen peroxide and an amount of hydrogen oxide with a strong acid to form a solution.
(B) Combining this solution with an amount of dipicolinic acid and an amount of hydroxyethylidene disphoshonic acid to form a compound solution.
(C) Combining the compound solution with water at the rate of 0.4 ounces compound solution per gallon of water.
(C) Applying the compound solution to cleanse industrial equipment.
(D) Applying the compound solution to cleanse food products, meat, poultry, seafood, and produce.
